(19) United States
(12) Patent Application Publication
(10) Pub. No.: US 2023/0339617 A1
(43) Pub. Date: Oct. 26, 2023

(54) METHOD FOR AIR-CONDITIONING THE CABIN OF AN AIRCRAFT ON THE GROUND ACCORDING TO THE AVAILABLE POWER SOURCES

(71) Applicant: REVIMA GROUP, RIVES-EN-SEINE (FR)

(72) Inventors: Romain BLANQUET, Brax (FR); Magdalena TRZECIAKOWSKA, Senneville-Sur-Fecamp (FR); Olivier HODAC, Toulouse (FR)

(21) Appl. No.: 18/305,568

(22) Filed: Apr. 24, 2023

(30) Foreign Application Priority Data
Apr. 26, 2022 (FR) 2203902

(51) Int. Cl. B64D 13/06

(52) U.S. Cl. CPC B64D 13/06; B64D 2013/0611

(57) ABSTRACT

Method for air-conditioning a cabin of an aircraft on the ground at an airport, by means of at least one electrical and/or pneumatic power source, including: a step of collecting, in real time, data on the aircraft and the flight plan thereof, the power sources, and the infrastructure of the airport, etc.; a step of determining the available power sources; a step of evaluating the performance level of each available power source as a function of a setpoint temperature and of collected data; a step of determining an optimal system including at least one available power source; if this optimal system is not used, the method further includes: an alert step; and a step of recommending the optimal system be used.

### CROSS REFERENCE TO RELATED APPLICATIONS

This application is based on and claims priority under 35 U.S.C. § 119 to French Patent Application No. 2203902, filed on Apr. 26, 2022, in the French Intellectual Property Office, the disclosure of which is incorporated by reference herein in its entirety.

### BACKGROUND

### Field

The present disclosure relates to the field of air-conditioning aircraft cabins, in particular airliners on the ground before take-off, and more particularly relates to a method for air-conditioning the cabin of an aircraft on the ground (during the embarkation phase for example) as a function of the electrical and pneumatic power sources available.

### Brief Description of Related Developments

In aviation, air conditioning is essential and primarily concerns the air conditioning in aeroplane cabins, especially when the weather conditions (outside temperature and humidity) are not conducive to passenger and crew comfort.

However, the use of air conditioning can far exceed the actual need and cause unnecessary excess energy consumption (waste) and thus higher operating costs for airlines.

Excessive use of air conditioning on board aeroplanes is commonly observed, whether due to excessively early preparations for departure, prolonged use on arrival or simple negligence (for example doors left open, or a setpoint temperature that is too low).

During a large number of stopovers and due to the thermal loads that the aeroplane is subjected to (solar radiation on the skin of the fuselage, heat dissipation of on-board electronic equipment, metabolic heat from the passengers, etc.), the use of air-conditioning becomes necessary to ensure passenger comfort.

The use of air conditioning is thus so important that it is one of the main items taken into account to determine the energy consumption of an aeroplane on the ground.

When an aeroplane is not connected to any external energy source, its Auxiliary Power Unit (APU) supplies the electrical and pneumatic energy required for air-conditioning the cabin. The fuel consumption of the APU is significant (from 120 kg/hour for a single-aisle aeroplane to over 300 kg/hour for a wide-body aeroplane).

Within a context of rising fuel prices and regulations imposing CO₂ emission limits at airports, limiting the use of the APU has become a necessity and this in particular involves optimising the use of air conditioning on an aeroplane.

More specifically, some airports have strictly regulated the use of APUs by aeroplanes transiting therethrough, either by prohibiting it for aeroplanes parked at the boarding gates or by prohibiting it altogether.

More specifically, while APUs are useful at airports where ground support is limited, most airports have now begun installing external power sources (fixed electrical ground power and pre-conditioned air system), typically at the boarding gates.

Connecting the aeroplane to an external source of pneumatic power such as a PCA (Pre-Conditioned Air) or an ACU (Air Conditioning Unit) is a more cost-effective solution and reduces CO₂ emissions (by a factor of at least 8) for air-conditioning the cabin of an aeroplane. However, as with the APU, ensuring optimal use of external power sources remains a challenging but particularly advantageous goal. Often, the cooling powers delivered by external pneumatic sources (PCA or ACU) are lower than those of the APU, and thus take longer to cool the cabin.

Having replaced the APU with a PCA or an ACU, the aeroplane must also be electrically powered by a ground power system such as a GPU (Ground Power Unit) or an FEGP (Fixed Electrical Ground Power). Whether the GPU is powered by a diesel engine or is hybrid, it can be more competitive than an FEGP but more CO₂ intensive.

Solutions exist for adjusting the temperature of the cabin of an aircraft during the preflight preparation of said aircraft.

By way of example, the US patent document No. 1075237662 describes a pre-flight readiness system for aircraft, comprising one or more electrical power modules, wherein an integrated controller is electrically and communicatively coupled with the power modules for monitoring and controlling them to provide electrical power to the aircraft's subsystems. In this solution, a portable device such as a smartphone can connect to the integrated controller to communicate preflight readiness instructions for the aircraft thereto and to monitor this preflight readiness. Furthermore, this document describes a method for preconditioning an aircraft comprising determining a state-of-charge of an APU and activating an environmental control subsystem for preconditioning the aircraft by adjusting a current temperature according to a preconditioning profile based on one or more parameters from among: a target temperature, a target time, a current temperature, an outside air temperature, an amount of energy and a state-of-charge of the APU.

However, this solution relies solely on the use of the APU, which is an internal power source, and does not take into account the presence of external power sources and does not offer the possibility of optimising the choice of the one or more power sources available to air-condition the cabin.

The French patent document No. 3019358B1 describes a method and a device for the optimised overall management of a power network of an aircraft comprising a plurality of items of power equipment, characterised in that it comprises a module for selecting at least one optimisation objective from a plurality of predetermined objectives, a module for receiving equipment data, a module for receiving aircraft data, and a module for determining operating setpoints of the power equipment from the equipment data and aircraft data, which are adapted to achieve at least one selected optimisation objective.

This solution also does not involve air conditioning that is optimised as a function of the internal and external power sources available when the aeroplane is on the ground.

### SUMMARY

The present disclosure aims to overcome the above drawbacks of the prior art and proposes a solution for recommending the one or more optimal power sources for air-conditioning a cabin of an aeroplane on the ground, taking into account consumption and thus the energy cost and carbon footprint.

Thus, one objective of the present disclosure is to optimise the air conditioning of a cabin of an aircraft on the ground by defining and recommending the right energy use required to reach a setpoint temperature as a function of multiple parameters including in particular said setpoint temperature, an outside temperature, an inside temperature, and a departure time for the aircraft, etc.

Another objective of the present disclosure is to achieve an optimum in both the choice of the pneumatic and electrical power source to be used on the ground and the duration of use thereof when preparing an aeroplane for departure.

To this end, the present disclosure relates to a method for air-conditioning a cabin of an aircraft on the ground at an airport, by means of at least one internal or external source of electrical and/or pneumatic power, and is noteworthy in that it comprises:
a step of collecting, in real-time, data including parameters from the aircraft, parameters from the power sources, aircraft flight data, and airport infrastructure and equipment data;
a step of determining the available internal and external power sources from an airport equipment database;
a step of evaluating, using specific algorithms, a performance level of each available power source as a function of a setpoint temperature to be reached in the cabin and of collected data;
a step of determining an optimal power system comprising at least one power source from among the available power sources;
a step of checking whether the optimal system is used; and
conditional steps for alerting and recommending the use of said optimal system if it is detected that this system is not used.

Advantageously, the parameters from the aircraft include an inside cabin temperature, an outside temperature, parameters of a main engine and of an APU, and the setpoint temperature.

According to the disclosure, the external power sources comprise a GPU, an ACU, a PCA and an FEGP.

According to one embodiment, the step of determining the available internal and external power sources implements algorithms for automatically detecting a connection between the aircraft and any power source.

According to one advantageous embodiment, the performance of a power source comprises its ability and the time required for said source to air-condition the cabin and achieve the setpoint temperature.

Advantageously, the step of determining the optimal system presents, for each power source, a selection level that depends on the performance of the source, a selection level that depends on an energy or monetary cost of using the source, and a selection level that depends on polluting emissions (CO₂) generated when using the source.

According to one embodiment, the step of determining the optimal system is carried out by machine learning.

The present disclosure further relates to a digital platform comprising computing and storage means, capable of communicating over a network, and configured to implement a method for air-conditioning a cabin of an aircraft on the ground as presented.

The basic concepts of the disclosure have been set out hereinabove in their most basic form, and other details and features will more clearly emerge on reading the following description and with reference to the accompanying drawings, which give, by way of a non-limiting example, one embodiment of a method for air-conditioning a cabin of an aircraft on the ground, in accordance with the principles of the disclosure.

### BRIEF DESCRIPTION OF THE FIGURES

The figures are given for illustrative purposes only for a better understanding of the disclosure, and do not limit the scope of the disclosure. The various elements are shown diagrammatically and are not necessarily to the same scale. In all of the figures, identical or equivalent elements bear the same reference numeral.

The drawings thus illustrate, in:

FIG. 1: a top view of a parked aircraft on the ground with external power sources in the vicinity thereof;

FIG. 2: a side view of a parked aircraft on the ground;

FIG. 3: a flow chart of the main steps of a method for air-conditioning an aircraft cabin according to the disclosure;

FIG. 4: an example implementation of the air-conditioning method according to the disclosure.

### DETAILED DESCRIPTION

It should be noted that certain technical elements well known to a person skilled in the art are described here to avoid any inadequacy or ambiguity in the understanding of the present disclosure.

In the embodiment described below, reference is made to a method for air-conditioning the cabin of an aircraft on the ground, intended primarily for airliners during their parking phase on the ground. This non-limiting example is provided to give a better understanding of the disclosure and does not rule out any implementation of the method in other types of aircraft that may also resort to the use of external power sources.

In the present description, some items of equipment are referred to by their acronyms which are commonly used in aviation jargon, and which signify the following:
APU: Auxiliary Power Unit;
GPU: Ground Power Unit;
ACU: Air Conditioning Unit;
PCA: Pre-conditioned Air;
FEGP: Fixed Electrical Ground Power.

Each of the aforementioned items of equipment will be generically referred to as an “electrical and/or pneumatic power source”, or simply as a “power source”. A power source is said to be internal when it belongs to the aircraft, and external when it does not belong to the aircraft and can only be connected thereto once on the ground. Thus, the APU and main engines of an aeroplane are internal power sources, whereas equipment such as GPUs, ACUs, PCAs and FEGPs are external power sources.

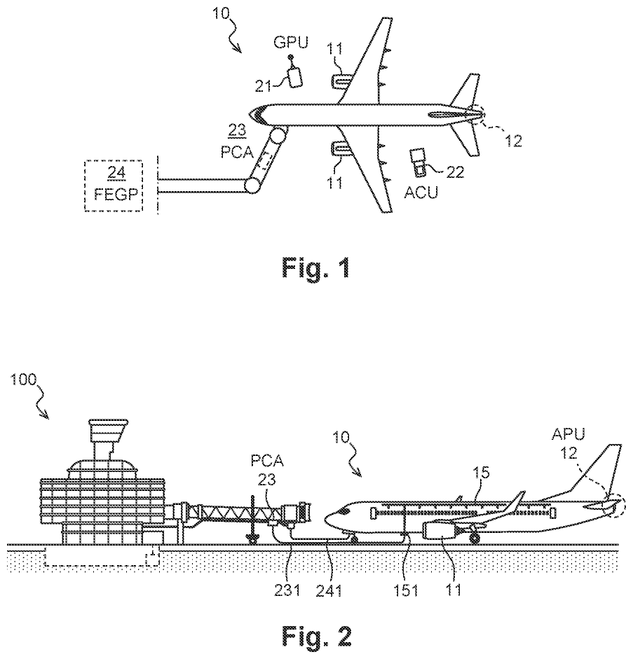

FIG. 1 shows an aeroplane 10 parked at a boarding gate of an airport, for example preparing for departure according to a predefined flight schedule. While parked on the ground, operations are carried out on the aircraft 10, in particular for embarking or disembarking passengers, loading or unloading cargo, refuelling and maintenance.

Some of these operations, in particular the embarkation of passengers, require the cabin of the aeroplane 10 to be air-conditioned. For this purpose, one or more internal or external electrical and/or pneumatic power sources can be used.

The internal power sources available to the aeroplane 10 on the ground include at least one main engine 11 and one APU 12.

The external power sources at the disposal of the aeroplane 10 can be a GPU 21, an ACU 22, a PCA 23, an FEGP 24, and any other similar system.

FIG. 2 shows the aeroplane 10, at an airport 100 in the vicinity of a boarding gate, being supplied with pneumatic power by a PCA 23 and with electrical power by an FEGP of the airport (not visible in the figure).

More specifically, the PCA 23 is connected to an air conditioning system 15 of the aeroplane 10 by means of flexible air ducts 231 connected to a suitable connection device 151 located in a lower part of the fuselage of the aeroplane.

The FEGP is, in turn, electrically connected to a socket of the aeroplane 10 by means of electrical cables 241.

The aeroplane 10 and the power sources available on the ground thus allow a method according to the disclosure to be implemented to optimise the air-conditioning of the cabin of said aeroplane as a function of several parameters.

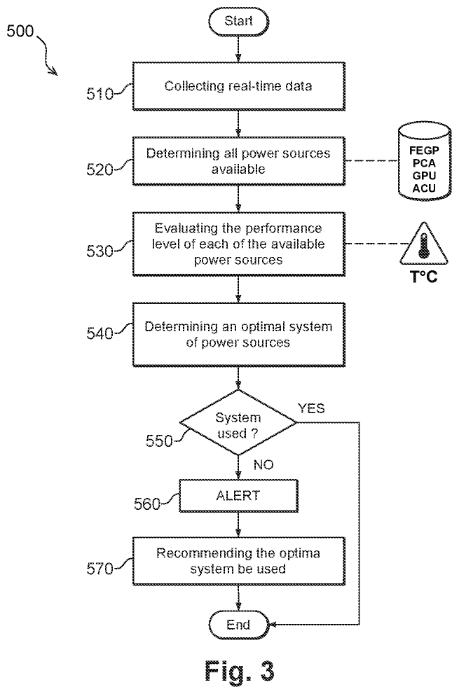

FIG. 3 shows the main steps of a method 500 for air-conditioning a cabin of an aeroplane on the ground as a function of the internal and external power sources available on the ground, said method comprising:
a step 510 of collecting real-time data from the aeroplane's equipment, power sources, the airport at which the aeroplane is located, and an airline operating the flight, etc.;
a step 520 of determining all internal and external power sources available to procure the air conditioning;
a step 530 of evaluating the capacity and performance level of each of the available power sources to reach a setpoint temperature;
a step 540 of determining an optimal system comprising at least one available power source, taking into account the evaluated performance levels;
a step 550 of checking whether said optimal system is used or intended to be used to supply the energy required to air-condition the cabin;
a conditional alert step 560 and use recommendation step 570, in the event of non-use of or no intention to use the optimal system;

It goes without saying that some of the steps can be carried out simultaneously or in reverse order. For example, steps 510 and 520 can be reversed or carried out simultaneously, and steps 560 and 570 can be carried out simultaneously, or can correspond to the same recommendation step which takes the form of an alert. Typically, these last two steps correspond to actions intended for the user (human operator) and can thus be adapted and carried out according to the needs of each user.

The data collection step 510 consists of collecting, in real time, a multitude of parameters on which the optimisation of the cabin air conditioning directly or indirectly depends. These parameters mainly originate from the aeroplane and the internal power sources thereof available on the ground, from the external power sources, from the airport and from the airline operating the flight.

The parameters from the aeroplane include, for example, engine and APU operating parameters, the inside cabin temperature, and the outside temperature measured by the aeroplane, etc.

The parameters from the external electrical and/or pneumatic power sources include the functional parameters thereof (power, duration, consumption, availability, etc.).

The parameters from the airport include, for example, information on the infrastructures, the equipment available, and the locations thereof, etc.

The parameters from the airline mainly include information from the flight schedule (flight departure and arrival times, stopovers, duration of stopovers, etc.).

This data is collected in real time via a digital platform for implementing the method guaranteeing real-time connectivity to the various aforementioned data sources.

For example, some data may be collected directly from networked databases (such as the internet), in particular from a database indicating the level of equipment of each boarding gate of the airport with external power sources, and a dedicated database showing the cost and carbon footprint of supplying one unit of electrical power (for example 1 kW) for each airport.

The step 520 of determining the internal and external power sources available on the ground consists of listing all of the power sources that may be used to supply the energy required for air-conditioning the cabin.

For example, algorithms for automatically detecting the aeroplane's connection to power sources can be used. As regards the internal sources (main engine and APU), these algorithms can directly detect the activity thereof from the avionics systems' data.

The performance evaluation step 530 consists of determining, for each available power source, an ability and a time required to reach the cabin setpoint temperature.

For example, the ability of a power source corresponds to its capacity to produce energy in a given form: electrical and/or pneumatic; and the time required depends directly on the power and operating rate of the source.

The performance is determined by means of specific algorithms implemented on the platform for implementing the method.

The step 540 of determining the optimal system then consists of choosing the best performing system given a cost function to be minimised.

The cost function can in particular be the economic cost or the CO₂ emission, etc.

It goes without saying that the optimal system can include one or more power sources in combination with one another.

The choice of the optimal system is made by selection levels, and thus by consecutively eliminating potential power sources as the selection progresses.

More specifically, from among all of the power sources, only those capable of supplying all of the necessary forms of energy are selected, then those with a necessary time that complies with the time remaining before the departure of the aeroplane (set by the departure time). Then, if at the end of this first selection, several systems remain possible, the economic cost and the carbon footprint will allow the optimal system to be selected.

For example, for passenger embarkation taking place at T0+55 min (T0 being the time at which the various power sources were queried), the platform for implementing the method analyses all possible pneumatic and electrical power supply options, and evaluates the performance levels as follows:

| Power | | Time to reach the setpoint | | Carbon |
|---|---|---|---|---|
| source | Status | temperature | Cost | footprint |
| APU | Available | 25 min | $75 | 215 kg CO2e |
| ACU | Unavailable | — | — | — |
| PCA | Available | 40 min | $15 | 22 kg CO2e |
| GPU | Available | — | $13 | 40 kg CO2e |
| FEGP | Available | — | $10 | 11 kg CO2e |

Based on this example, it is determined that the optimal solution is the use of the PCA and the FEGP. If embarkation is scheduled for T0+30 min, then the APU must be used.

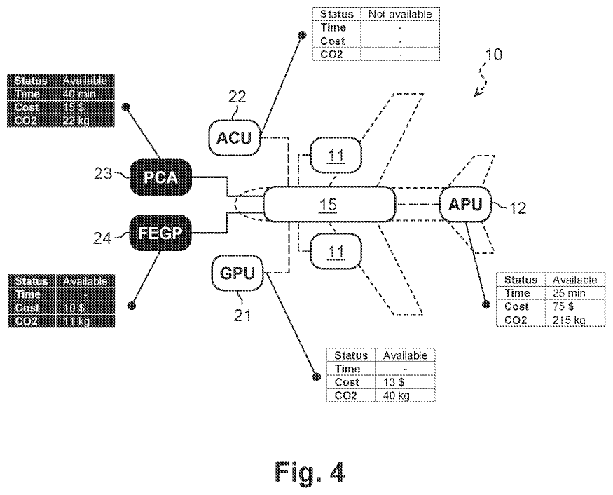

FIG. 4 illustrates this scenario and also gives an example of a possible graphical interface for using the method on a user terminal.

This interface can be supplemented by a special display in the case of an alert, intended for the ground staff (handler) and the technical staff of the airline operating the flight.

The step of determining the optimal system can be carried out by machine learning so as not to compare all of the evaluated performances of all of the available power sources upon each implementation of the method, and to more efficiently recommend the optimal system based on the past recommendations made to users. The information history thus constitutes training data, the quantity whereof increases as the software solution associated with the method is rolled out to users.

It is clear from the present description that some steps of the method can be modified, replaced or omitted and that certain adjustments can be made to the implementation of this method according to the objectives sought, without departing from the scope of the disclosure.

What is claimed is:

1. Method for air-conditioning a cabin of an aircraft on the ground at an airport, by means of at least one internal source or external source of electrical and/or pneumatic power, characterised in that it comprises:
a step of collecting, in real-time, data including parameters from the aircraft, parameters from the power sources, aircraft flight data, and airport infrastructure and equipment data;
a step of determining the available internal and external power sources from an airport equipment database;
a step of evaluating, using specific algorithms, a performance level of each available power source as a function of a setpoint temperature to be reached in the cabin and of collected data;
a step of determining an optimal power system comprising at least one power source from among the available power sources;
a step of checking whether the optimal system is used; and
conditional steps for alerting and recommending said optimal system be used if it is detected that this system is not used.

2. Method according to claim 1, wherein the parameters from the aircraft include an inside cabin temperature, an outside temperature, parameters of a main engine and of an APU, and the setpoint temperature.

3. Method according to claim 1, wherein the external power sources comprise a GPU, an ACU, a PCA and an FEGP.

4. Method according to claim 1, wherein the step of determining the available internal and external power sources implements algorithms for automatically detecting a connection between the aircraft and any power source.

5. Method according to claim 1, wherein the performance of a power source comprises its ability and the time required for the source to air-condition the cabin and achieve the setpoint temperature.

6. Method according to claim 1, wherein the step of determining the optimal system presents, for each power source, a selection level that depends on the performance, a selection level that depends on an energy or monetary cost of using said source, and a selection level that depends on polluting emissions generated when using the source.

7. Method according to claim 1, wherein the step of determining the optimal system is carried out by machine learning.

8. Digital platform comprising computing and storage means, and capable of communicating over a network, characterised in that it is configured to implement a method for air-conditioning a cabin of an aircraft on the ground, according to claim 1.
